(19) United States
(12) Patent Application Publication
(10) Pub. No.: US 2011/0314413 A1
(43) Pub. Date: Dec. 22, 2011

(54) USER INTERFACE

(76) Inventors: Stephen Kunkler, New South Wales (AU); John Raciti, Mascot (AU); Caevan Sachinwalla, New South Wales (AU); Brent Jackson, New South Wales (AU)

(21) Appl. No.: 13/120,977

(22) PCT Filed: Sep. 25, 2009
(86) PCT No.: PCT/AU09/01274

§ 371 Date: Sep. 7, 2011

(30) Foreign Application Priority Data
Sep. 25, 2008 (AU) 2008905003

(51) Int. Cl. G06F 3/048

(52) U.S. Cl. 715/781

(57) ABSTRACT

A graphical user interface (10) is disclosed. The interface has a display area (16) having a first area (18) and a second area (20). A graphical interface unit (22) is displayed in the display area (16) and is moveable between the first area (18) and the second area (20).

### FIELD OF THE INVENTION

The present invention generally relates to graphical user interfaces, and particularly but not exclusively to a user interface for an internet banking service.

### BACKGROUND OF THE INVENTION

Computer based transactions, such as those performed over an Internet banking service, traditionally have a fixed navigation system in which a fixed left side and a top navigation bar are used. To perform a transaction, view a balance or perform another function, a user clicks on items in the bars to enter a multi-level navigation system. Typically, the process of making a transaction or viewing a balance requires navigation through a hierarchy of menus requiring many steps before the process is completed. Also, the navigation system is typically inflexible and cannot be tailored to the user or by the user.

### SUMMARY OF INVENTION

According to a first aspect of the invention there is provided a graphical user interface comprising:

a display area having a first area and a second area;

the display area being arranged to display a graphical interface unit, the unit being movable between the first area and the second area.

In an embodiment, the unit is one of a plurality of graphical interface units.

In an embodiment, the unit has a first configuration when displayed in the first area and a second configuration when displayed in the second area. The configuration of the unit may be changed when the unit is moved between the first area and the second area. The unit may have a third configuration in which the unit substantially occupies the display area. The unit may have an area, the area being smaller in the first configuration than in the second configuration. Information may be displayed in both the first and second configurations that is dependent on the configuration of the unit. The unit may be collapsed in the first configuration and expanded in the second configuration. The unit may further comprise a presentation area in the second configuration but not in the first configuration.

In an embodiment, the unit comprises a window.

In an embodiment, the unit further comprises an interactive element having a preset configuration. The preset configuration may have been set during a previous use of the interface. The interactive element may be one of a radio button, pop up menu, and check box.

In an embodiment, the unit comprises a text box containing preset text. The preset text may have been entered during a previous use of the interface.

In an embodiment, the interface is arranged for facilitating a transaction with a financial institution. The transaction may be one of depositing funds, transferring funds between two accounts, paying a credit balance, and making a payment with a bill payment system such as BPAY. The unit may be arranged for facilitating the transaction with the financial institution.

In an embodiment, the unit displays one or more of: account information; and a recent transaction.

In an embodiment, the unit is one of a first and a second graphical interface units, the first unit being arranged for a user to make a transaction using an associated account, and the second unit presenting information associated with the account.

In an embodiment, the first area allows a user to navigate between a plurality of units.

In an embodiment, the second area allows a user to interact with the unit.

According to a second embodiment of the invention there is provided a graphical user interface comprising:

a display area arranged to display a first and a second graphical interface unit, the first unit being arranged for a user to make a transaction using an associated account, and the second unit presenting information associated with the account.

In an embodiment, the information presented by the second unit is updated after the transaction has been processed. The information presented by the second interface may be updated within a predetermined time period. The time period may be 0.1 seconds. Alternatively, the time period may be one of: one; five; and 60 seconds after the transaction.

In an embodiment the display area has a first area and a second area, and the first and second units are movable between the first area and the second area.

According to a third aspect of the invention there is provided an internet banking service comprising a graphical user interface in accordance with either the first or second aspects.

According to a fourth aspect of the invention there is provided a computing system arranged to provide interface information indicative of a graphical user interface in accordance with either the first or second aspects. The computing system may comprise a web server and the interface information may be web page information.

According to a fifth aspect of the invention there is provided a software program, including at least one instruction arranged to implement a graphical user interface in accordance with the first or second aspects of the invention.

According to a sixth aspect of the invention there is is provided logic encoded in one or more tangible media for execution and when executed operable to provide interface information indicative of a graphical user interface in accordance with the first or second aspects of the invention.

According to a seventh aspect of the invention there is provided a computing system for generating a graphical user interface, the system comprising:

a processor arranged to generate display area data and graphical interface unit data, the display data and interface data comprising instructions for rendering a display area on an electronic display and a graphical interface unit on the display area, the display area having a first area and a second area; and

a human machine interface arranged to receive one or more commands from a user, such that in response to the one or more commands the unit is moved between the first area and the second area.

### BRIEF DESCRIPTION OF THE FIGURES

In order to achieve a better understanding of the nature of the present invention embodiments will now be described, by way of example only, with reference to the accompanying figures in which:

FIG. 1 shows one embodiment of a graphical user interface for display on a screen or display;

FIG. 2 shows one embodiment of an internet banking system;

FIG. 3 shows a screen shot of one embodiment of a graphical user interface;

FIGS. 4 and 5 show arrangements of another embodiment of a graphical user interface;

FIG. 6 shows an example of a computing architecture; and

FIG. 7 shows an example of a log in page for a web based service

### DETAILED DESCRIPTION OF EMBODIMENTS OF THE INVENTION

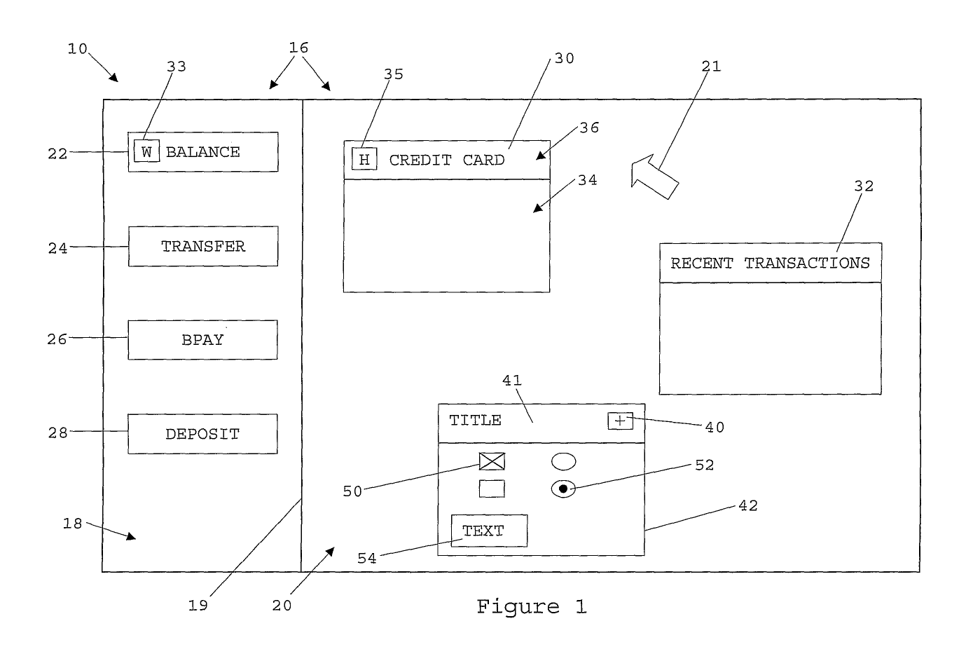

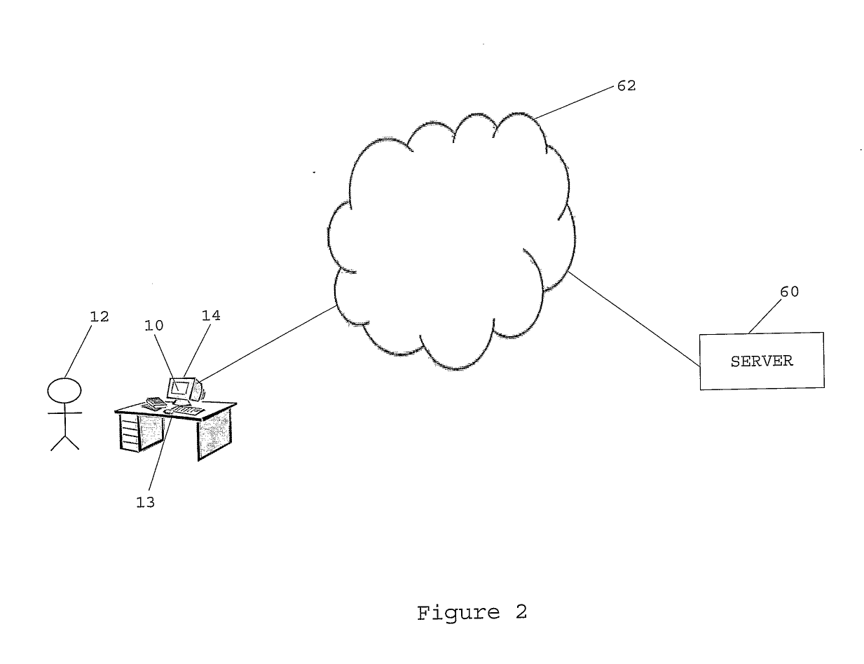

FIG. 1 shows a snapshot of one embodiment of a graphical interface generally indicated by the numeral 10. As shown in FIG. 2, in this embodiment the interface 10 is displayed on a machine such as a personal computer or terminal 14. The computer 14 is connected over a network 62 such as the internet to a computing system, in this embodiment a server 60. Typically, the interface 10 is implemented as a web page rendered by a web browser on the computer 14 used by the user 12. A financial institution or its agent controls the server 60 which provides interface information indicative of the graphical user interface 10. In this case, the interface information is web page information defining the web page rendered by a web browser running on the computer 14.

The interface 10 shown in FIG. 1 allows the user 12 to communicate with the server 60. The interface 10 has a display area 16. The display area 16 may comprise, for example, the entire display area of a computer monitor (electronic display) or be contained within a window shown on the computer monitor. The display area 16, in this embodiment, is divided into a first holding area 18 and a second workspace area 20. A line 19 separates the holding and workspace areas but it need not be present in all embodiments. In some embodiments, the holding and workspace areas are on different displays of the same machine 14 or may even be arbitrarily shaped areas contained within the display area.

The graphical interface 10 is arranged, at least in this embodiment, for facilitating transactions with the financial institution or providing information about an account held with the financial institution by the user 12. The interface 10 may facilitate, for example the depositing of funds, the transferring of funds between two or more accounts, paying a credit balance, making a BPAY payment or other banking operation. The units may also display account information such as the account balance 22 and a list of recent transactions 32.

It will be appreciated that the interface can form part of any financial service such as that provided by a bank, insurance company or brokerage. The account may not be merely a savings account, but could be any type of account such as a term deposit, credit card, mortgage, or even a trading account for instruments such as shares, for example. It will be appreciated that an interface such as 10 is widely adaptable to any number of transactions including but not limited to financial transactions.

The display area 16 includes a plurality of graphical interface units such as 22, 24, 26, 28, 30, 32 and 42. The units are moveable by the user 12 around the display area 16 by use of a moveable pointer 21 controlled by, for example, a computer mouse 13. In this embodiment, the graphical interface units such as 30 and 32 are windows having a presentation area 34 and a window control area 36. To move the window 30 the user 12 places the pointer 21 over the window control area 36, presses a mouse button and drags the window 30 around the display area 16 whilst the mouse button is depressed.

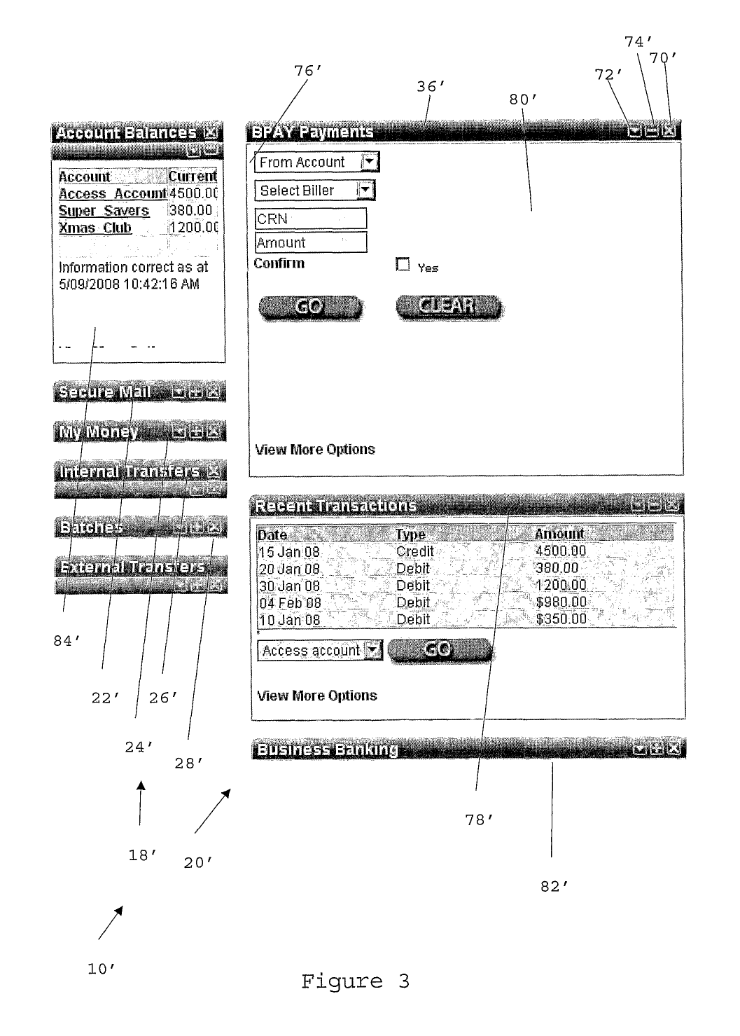

FIG. 3 shows a screen shot of another embodiment of a graphical user interface 10′. It has a holding area 18′ and a workspace area 20′. The window control area 36′ may also include controls to close 70′, enlarge 72′, or collapse 74′ the window 76′. The units such as 76′ can be moved by the user between the holding area 18′ and the workspace area 20′. The units located in the holding area 18′, such as 22′ to 28′, have a first configuration and the units located in the workspace area 20′, such as 76′ and 78′, have a second configuration. Most of the windows in the holding area 18′ are collapsed so that the window control area 36′ is visible but not the presentation area 80′. Alternatively, the windows may be collapsed in both the workspace and holding area (see 28′ and 82′ for example) and the different configuration requires a different configuration of some aspect of the control area. In FIG. 3, the aspect of the control area that is reconfigured is its length. The windows in the holding area 18′ may be expanded so that the presentation area is visible, as for 84′.

Returning to FIG. 1, the units are changed from the first configuration to the second configuration when the user drags it from the holding area 18 to the workspace area 20 or vice versa. The holding area can be seen as a navigation or menu area where the user can select a type of banking operation (or other type of operation) to perform. It also allows the units to be temporarily ‘parked’ until required and then they are moved out, thus the holding area may be called a parking area. By dragging a collapsed window, such as 22, from the holding area 18 to the workspace area 20 the unit becomes operational and the user may perform transactions, view balances, etc. In the workspace area 20 the main presentation area 34 is displayed and populated with information, interactive elements such as radio buttons 52, pop-up menus, check boxes 50 and text boxes 54.

In another embodiment, at least some of the units may be moved between the holding area 18 and the workspace area 20 or vice versa by a means other than dragging a unit from one of the areas to the other. In one embodiment, the units include buttons such as 33 and 35 as shown in FIG. 1. When pressing the button 33 (a “move to workspace” button labeled W) of the unit 22 in the holding area, the unit is moved by the system and/or software from the holding area to the workspace area. Conversely, when the button 35 (a “move to holding area” button labeled H) is pressed on the unit 30, the software causes the unit 30 to move from the workspace area to the holding area. Similarly for other described embodiments, the unit is changed from the first configuration to the second configuration when it is moved between the holding area and the workspace area and vice versa. In some other embodiments, one or more keystrokes made on a keyboard by the user may cause a unit to move between the holding and workspace areas. In yet another embodiment, a voiced command by the user and received via microphone by the system may cause a unit to move between the holding area and the workspace area.

One or more units may in some embodiments be configured to accept a command from the user to show more details. For example, in response to the user clicking on a button displayed on the unit, the unit area may be increased and more details presented to the user on the increased unit area. In an embodiment, a single click anywhere will return the interface to its configuration before the command was accepted. That is, the user is only one click away from the default interface. In this embodiment, the display beyond the unit boundary is de-highlighted, by dimming it or making it grey for example. In some embodiment, the unit occupies the whole display area when maximized. In some embodiments, the single click must be in a certain area or button (or alternatively a key stroke or through another command delivery device) to return the interface to its configuration before the command was accepted.

In some embodiments, the windows such as 30 can be arbitrarily moved and placed anywhere in the workspace area 20 such as in FIG. 1. In alternative embodiments such as FIG. 3, however, the windows are snapped into set positions, such as columns or onto set points located in the workspace area.

The windows or units such as 30 may also have a third configuration. In this configuration, the window 30 substantially covers the workspace area 16. In some other embodiments, the window may substantially (or totally) occupies the display area 16. With reference to FIG. 1, the user may achieve this by clicking a button such as 40 in the window control area (or window bar) 41 of a window such as 42.

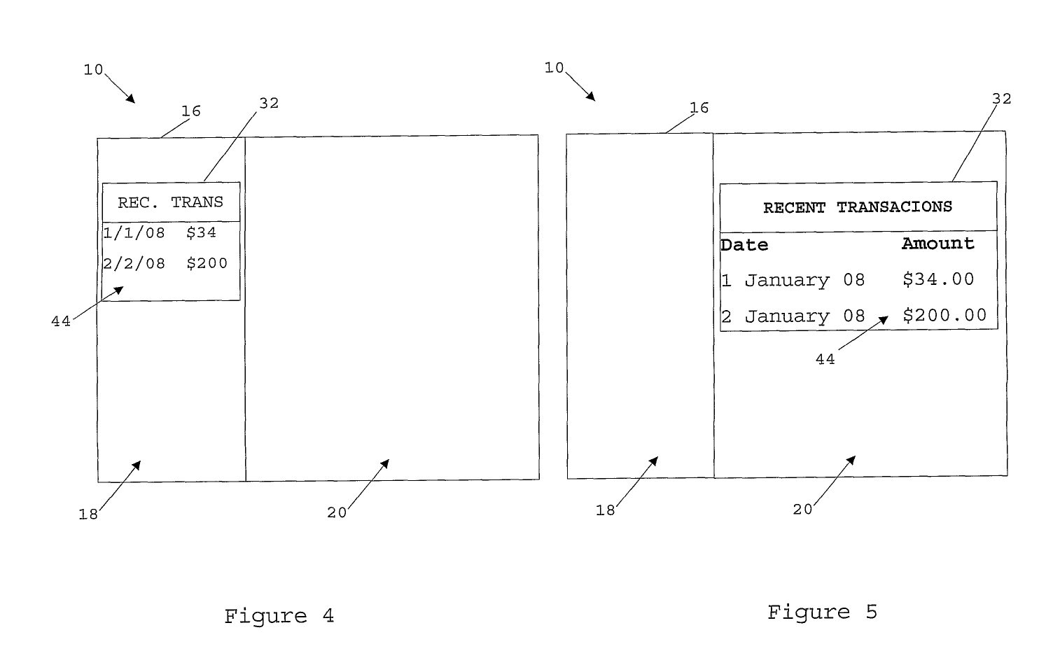

In some embodiments, a unit or window such as 32 displays information while it is both in the holding area 18 and the workspace area 20 as shown in FIGS. 3 and 4 respectively. In this case, the window 32 has a smaller area when it is in the holding area 18 than in the workspace area 20. The information presented in the presentation area 44 of the window 32 may be smaller when the window 32 is in the holding area 18 than when it is in the main presentation area 20. Also, the information is presented and/or formatted differently in the first and second configurations, in this case to allow a compression of presentation area. For example, in FIG. 4 where the unit is in the holding area 18 the dates are abbreviated and the cents for the transactions have been omitted, however in FIG. 5 where the unit is in the workspace area 20 the dates are less abbreviated. Also the headings are omitted in FIG. 3. Headings may be abbreviated and text style changed also.

As shown in FIG. 1, in this embodiment window 42 includes check boxes such as 50 and radio buttons such as 52. The checking or selection of the check boxes and radio buttons respectively have been remembered by the interface 10, computer 14 or preferably the server 60, the configuration of these interactive elements being set by the user during a previous session in which the interface 10 was used by the user 12. The text box 54 similarly includes text entered in the previous session.

The interface is configurable by either the user 10 or the computer 14 or server 60. For example, the server 60 may provide a default arrangement of the windows such as 22 to 30 when the user 12 logs on for the first time. In this first session, the user may modify the position and configuration of the windows and the server 60 may remember this for future sessions. Also, the system 60 may have some information regarding the expertise of the user 16 and configure the interface accordingly. The user 12 may, for example, routinely perform some types of transactions (such as recent transactions 32) and in this case the windows facilitating these transactions may be in the workspace area 20 by default. The other types of transactions represented by windows 22 to 28 in FIG. 1, for example, may be stored in the holding area 18 and only moved across to the workspace area 20 for occasional use when required.

The information in the windows such as 22 (balance), (recent transactions) and 24 (transfer) may be linked. For example, if the user 12 makes a transfer (or other transaction) using unit 24 then the account balance shown in window 22 and the recent transactions shown in window 32 may be updated in accordance with the transfer (or transaction). Similar updates may occur for a deposit, a BPAY payment or a credit card payment for example. Ideally, the time interval between the user finishing the transaction and the update is less than 0.1 seconds so is that it appears instantaneous to the user. However, a time period of less than 1 second still provides no appreciable hindrance or delay. A time period of up to 5 seconds would be acceptable in many embodiments. In some embodiments, a delay of between 5 seconds and 60 seconds may be acceptable, especially if the period between transactions is significantly greater than this. This time period may allow, for example, confirmation of the transaction before providing the update.

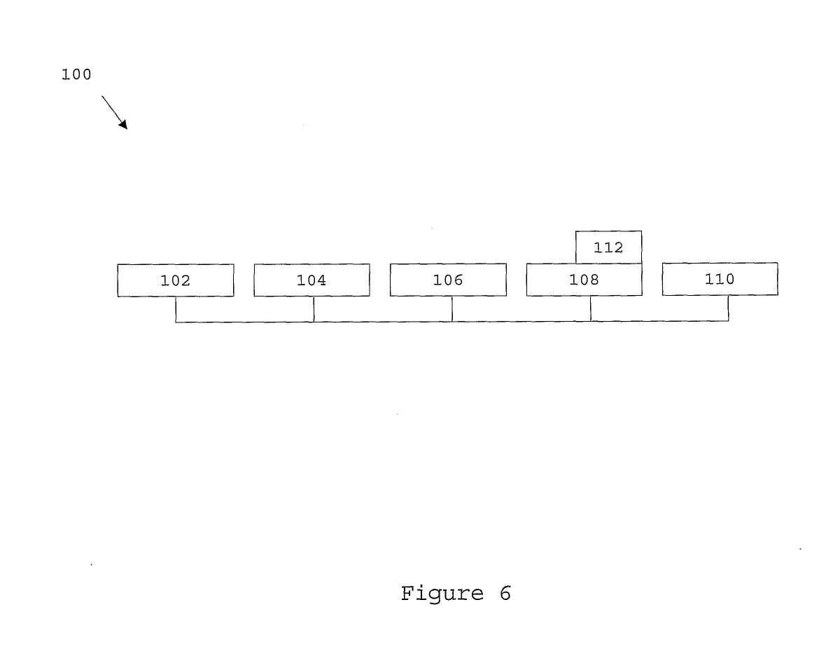

The computing system 60 and machine 14 implement the interface with the aid of appropriate computer hardware and software. One example of an architecture 100 suitable for both the machine and computing system are shown in FIG. 6. The computing architecture 100 comprises suitable components necessary to receive, store and execute appropriate computer instructions. The components may include a processing unit 102, read only memory (ROM) 104, random access memory (RAM) 106, storage devices 108, and communication links 110 such as an Ethernet port, a USB port, etc. The computing system 100 includes instructions that may be included in ROM 104, RAM 106 or disk drives 108 and may be executed by the processing unit 102. There may be provided a plurality of communication links 110 which may variously connect to one or more computing devices such as a server, personal computers, terminals, wireless, handheld computing devices or other devices capable of receiving and/or sending electronic information. At least one of a plurality of communications links may be connected to an external computing network through a telephone line, an Ethernet connection, or any type of communications link. Additional information may be entered into the computing system or machine by way of the user interacting with a human machine interface comprising suitable input devices such as, but not limited to, a keyboard and/or mouse (not shown).

The architecture may include storage devices such as a disk drive 108 which may encompass solid state drives, hard disk drives, optical drives or magnetic tape drives. The computing system 100 may use a single disk drive or multiple disk drives. A suitable operating system 112 resides on the disk drive or in the ROM of the computing system 100 and cooperates with the hardware to provide an environment in which software applications can be executed.

In particular, the data storage system is arranged to store software including logic that controls the interface 10. Typically, the logic is stored on the data storage system including tangible media such as a hard drive, flash memory, RAM, DRAM, DVD or CD-ROM or other form of media in which the logic can be stored. The data storage system may be loaded with a module having various sub-modules (not shown). The sub-modules are arranged to interact with the architecture 100, via the operating system 112, to either receive and/or process information.

Although not required, the embodiments described herein can be implemented as an application programming interface (API) or as a series of libraries for use by a developer, or can be included within another software application, such as a terminal or personal computer operating system or a portable computing device operating system. Generally, as program modules include routines, programs, objects, components and data files which work together to perform particular functions, it will be understood that the functionality may be distributed across a number of routines, programs, objects components or data files, as required.

In one embodiment the interface is implemented using web pages provided by a service such as a banking service. In some of these embodiments, the main page, of which FIGS. 1 and 3 are examples, is seen by the user after logging in for a session with the service. The main page can display several linked (or not linked) pages simultaneously, each page being presented in one of the displayed units. The user may be able to view a number of pages from the one main page. All the activities for one site/session are viewed from the single main page. There is no requirement for the user to be directed to other external tabs or windows. The user may place less regularly used units having associated features or transactions in the holding or parking area.

The main page is driven by a banking application that, in some embodiments, enables users to access multiple services of banking at one given time. In one embodiment, after log in the user is immediately presented units in the workspace area for showing an account balance, a recent transaction and making a payment with a bill payment system such as BPAY. For some users these banking functions are the most used. The choice of units—and thus possible banking functions—shown after the user logs in in some embodiments is determined by user usage statistics. In this case, the user may be able to bank according to their behavior with less clicks and/or steps.

The interface is implemented in one embodiment using Widgets and Ajax technology. Ajax (Asynchronous JavaScript and XML), or AJAX, is a group of interrelated web development techniques used for creating interactive web applications or rich Internet applications. With Ajax, web applications can retrieve data from the server asynchronously in the background without interfering with the display and behavior of the existing page. Data is retrieved using the XMLHttpRequest object or through the use of Remote Scripting in browsers that do not support it. Despite the name, the use of JavaScript, XML, or its asynchronous use is not necessarily required.

The interface makes use of a customized architecture. This architecture uses “widgets” that support several HTML objects concurrently, including but not limited to iFrames, ASP.NET user controls, Flash objects and Silverlight. All widgets are processed independently, and do not rely upon the completion of other widgets inside the framework to perform its defined activity. To reduce key strokes some widgets drive a secondary action within a second widget where there is a logical connection. This design reduces the number of screens and clicks required by the user. Ajax is used to customize the drag and drop process, and for the processing of the widgets. The result for the user is a real time post back experience not dependent upon full page submissions.

In some embodiments, the units may take the form of desktop widgets, for example a dashboard type widget for an Apple Macintosh under OSX. In other embodiments, the units may take the form of Mobile Widgets running on a mobile telephone. The widgets may alternatively be web widgets running on a web browser used as a widget engine infrastructure, or even a TV set widget.

Units, in some embodiments, are implemented using boxes as defined by Ajax. The user is able to arrange and customize these drag-able widgets. All expanded units are loaded on the main page first. Collapsed boxes that are parked in the holding area on the left-hand side of the page are loaded on the page only when the user is accessing the information, that is when the box is expanded, and preferably when in the working area of the page. Each widget is linked to a HTML Object; the content on the main page is a collection of widgets containing different HTML Objects—which the user can access at the same time. Each widget is more than a preview box. Each widget (or unit) contains a rendering of a HTML Object appropriate for that widget. The user is able to process information in these widgets. An advantage provided by using Widgets/Ajax technology is that only the widget (unit) containing the information that is accessed on the page is refreshed—not the whole main page. This is advantageous as it saves the user's time.

Thus, some embodiments of the system include advance technology web pages that are designed to work with low speed and high speed internet.

In another embodiment, the interface runs on a web browser and units are rendered on a web browser window. On the user clicking on a “move to work space” button, labeled W, or the “move to holding area” button, labeled H, the system causes the web browser window to be refreshed with the unit having been moved between the holding and workspace areas within the browser window as appropriate. The unit may be reconfigured during the refresh. In this embodiment AJAX would not necessarily need to be used. Individual request may be sent back to the server which reconstruct the page information for rendering on the user's browser.

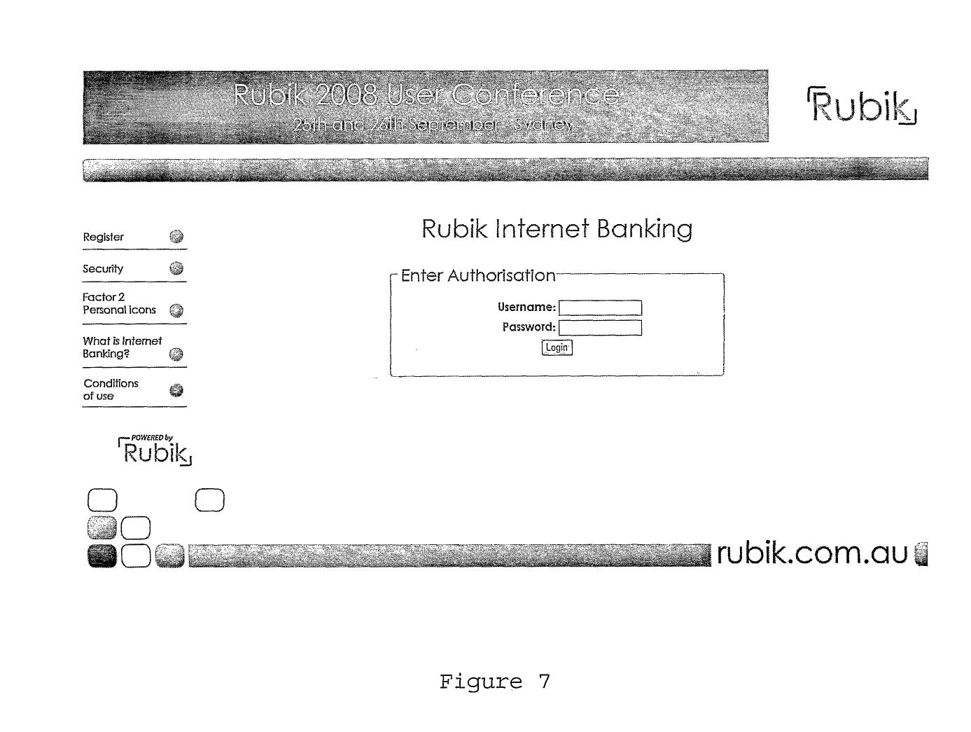

FIG. 7 shows one embodiment of a first page seen by the user of an web based service, in this case an Internet banking service. It is a log in page. The user will access a main page, such as shown in FIG. 3, after successfully logging in. This main page then provides the end customer with direct access to all available data and functions required for Internet Banking. Different functions and features of the Internet Banking system are summarized in individual Widgets. All these windows are loaded once only post successful logon, and then managed using Ajax technology, meaning all subsequent requests are handled as servlet or sub page requests.

An example:—
Consider an Account Balance window. The Account Balance Widget loads initially the Account Balance aspx page. The Account Balance aspx has a grid used to display the users individual account balances. This page uses Ajax technology to populate the grid. So as to avoid loading a page load for each transaction it is possible to use a further page to manage database and information requests (such as for account balances). That page is called the Account balance server page.

An example sequence of fetching and showing a customer account balance in the main page follows:

1. The customer logs into the Internet Banking system and is redirected to Main page.
2. Before the Main page loads, all Widgets are loaded.
3. For example, the Account balance web page is populated using the Account balance Widget.
(a) Account balance web page, sends Customer account information to a customer balance server page through a high security protocols.
(b) Account balance server page, get the user account info and connect to database and get a user account balance data of a specific user and convert it to xml string and send it back to account balance web page.
(c) Account balance web page gets the xml sting and shows it in a grid view.
   4. In the Main Page, the Account Balance web page is loaded within the Account balance Widget.

Some data with each Widget may be linked or relate to other Widgets. For example, BPAY payments will result in the account balances being update without the need to reload the entire page.

The navigation place holders can be based upon a left hand navigation model or top navigation model, for example. In fact the less frequently used functions can be stored in any location on the Main Page, but for the purposes of the examples we have used the Left Hand Navigation model, that is a holding area on the left hand side of the display area.

Following are sample code extracts highlighting how to implement this solution using Widgets and AJAX. For the purposes of this code extract, comments only have been included where database and message requests would normally be placed.

```
Internet banking Main page:
public partial class UI_InetbankMain : System.Web.UI.Page
{
  protected void Page_Load(object sender, EventArgs e)
  {
    //populating Widgets
    //loading header advertisement
  }
}
Internet banking Account Balance page:
<script language=javascript>
//Creating a secure URL (This URL includes a AccountBalanceServer page
path + Customer Account ID)
//Creating a XML Request for passing URL to server and waiting for
result (This part of code is implemented by Ajax to avoid a page in
Balance Account page to be loaded)
//Filling a Balance Account Grid by Results which have gotten from a
Account Server Page
</script>
Internet banking Account Balance Server page:
public partial class UI_InetBankAccBalance : System.Web.UI.Page
{
  protected void Page_Load(object sender, EventArgs e)
  {
    //Getting Customer account information and checking it
//Connecting to DB and get Account balance information of a customer
//Converting selected Account balance data to xml and passing it to a
AccountBalance page
  }
```

It will also be appreciated embodiments are implemented with the aid of an architecture, or partly implemented by an architecture. Any appropriate architecture may be used. This includes stand alone computers, network computers, dedicated computing devices, or any device capable of receiving and processing information or data. Where the terms “computing system” and “computing devices” are utilised throughout the specification, these terms are intended to cover any appropriate arrangement of computer hardware and/or software required to implement at least an embodiment of the invention.

Now that embodiments have been described, it will be appreciated that some embodiments have some of the following advantages:
A simplified navigation system is provided.
The new system is significantly flattened requiring less steps to complete a transaction or task than using some other navigation or menu systems.
The use of tabs or complicated menu systems having multiple levels is avoided.
A virtual navigation system is provided.
The user can customize the interface and modify it for maximum efficiency.
There are less buttons for the user to press to get to what he/she usually wants.
There is less information for a server to load as the windows and all their contents are substantially loaded at the start of the session.

It will be appreciated that numerous variations and/or modifications may be made to the invention as shown in the specific embodiments without departing from the spirit or scope of the invention as broadly described. For example, the server 60 may contain the medical records of a patient and the interface 10 may facilitate the viewing of patient medical information. In one variation, one unit may be configured to show the patients current medications and dosages, another may be configured to show pathology or test results, and yet another any known conditions or abnormalities. The server 60 may be controlled by a hospital, area health service, or government department, for example, or their agent. In one example, the units may each be portal applications, providing data presentation and data manipulation capabilities for generally any type of data. In another example, the units may connect to a core banking system and different users, for example a bank manager and a teller, who have different banking data requirements can customize the units for their purposes. The present embodiments are, therefore, to be considered in all respects as illustrative and not restrictive.

For example, the term “server” in this specification is intended to encompass any combination of hardware and software that performs services for connected clients in part of a client-server architecture. The client and a server may be separate software running on a single piece of hardware or a plurality of connected pieces of hardware. Combinations include main frame and terminal, server and thick or thin client, web server and browser, etc.

1-29. (canceled)

30. A graphical user interface comprising:
a display area having a first area and a second area;
the display area being arranged to display a graphical interface unit, the unit being movable between the first area and the second area;
the unit having a first configuration when displayed in the first area and a second configuration when displayed in the second area;
the interface being arranged for facilitating a transaction with a financial institution.

31. An interface defined by claim 30, wherein the unit is one of a first and a second graphical interface units, the first unit being arranged for a user to make a transaction using an associated account, and the second unit presenting information associated with the account.

32. An interface defined by claim 31, wherein the present information associated with the account is updated after the transaction without reloading the first and second units.

33. An interface defined by claim 30, within a position of each of the units with respect to the first and second areas during a session in which the interface is used is remembered for a subsequent session.

34. An interface defined by claim 31, wherein the units and their respective contents are substantially loaded at the start of a session in which the interface is used.

35. An interface defined by claim 30, wherein the configuration of the unit is changed when the unit is moved between the first area and the second area.

36. An interface defined by claim 30, wherein the unit has a third configuration in which the unit substantially occupies the display area.

37. An interface defined by claim 30, wherein the unit has an area, the area being smaller in the first configuration than in the second configuration.

38. An interface defined by claim 30, wherein information displayed in both the first and second configurations is dependent on the configuration of the unit.

39. An interface defined by claim 30, wherein the unit is collapsed in the first configuration and expanded in the second configuration.

40. An interface defined by claim 30, wherein the unit comprises a window.

41. An interface defined by claim 30, wherein the unit further comprises a presentation area in the second configuration but not in the first configuration.

42. An interface defined by claim 30, wherein the unit further comprises an interactive element having a preset configuration.

43. An interface defined by claim 42, wherein the preset configuration was set during a previous use of the interface.

44. An interface defined by claim 30, wherein the unit displays one or more of account information and a recent transaction.

45. An interface defined by claim 30, wherein the unit is one of a plurality of units.

46. An interface defined by claim 30, wherein the first area allows a user to navigate between a plurality of units.

47. An interface defined by claim 30, wherein the second area allows a user to interact with the unit.

48. An interface defined by claim 30, wherein the unit is dragable between the first area and the second area.

49. An internet banking service comprising the graphical user interface of claim 30.

50. A computing system arranged to provide interface information indicative of a graphical user interface defined by claim 30.

51. A computing system defined by claim 50, comprising a web server and the interface information is web page information.

52. Logic encoded in one or more tangible media for execution and when executed operable to provide interface information indicative of a graphical user interface defined by claim 30.

53. A computing system for generating a graphical user interface, the system comprising:
a processor arranged to generate display area data and graphical interface unit data, the display data and interface data comprising instructions for rendering a display area on an electronic display and a graphical interface unit on the display area, the display area having a first area and a second area;
the unit having a first configuration when displayed in the first area and a second configuration when displayed in the second area;
the interface being arranged for facilitating a transaction with a financial institution; and
a human machine interface arranged to receive one or more commands from a user, such that in response to the one or more commands the unit is moved between the first area and the second area.
